(19) United States
(12) Patent Application Publication
(10) Pub. No.: US 2018/0239172 A1
(43) Pub. Date: Aug. 23, 2018

(54) Eyeglasses Frame Selection System and Device

(71) Applicant: Ward Cochrane, Vancouver (CA)

(72) Inventor: Ward Cochrane, Vancouver (CA)

(21) Appl. No.: 15/437,174

(22) Filed: Feb. 20, 2017

(51) Int. Cl. G02C 13/00; H04N 5/272; H04N 1/00; H04N 1/21

(52) U.S. Cl. CPC G02C 13/003; H04N 5/272; H04N 1/00212; H04N 2201/0084; H04N 1/00129; H04N 2005/2726; H04N 1/2112

(57) ABSTRACT

The invention is a system and device that allows people to choose the proper eyeglass frames. A kiosk or other unit is used. It is equipped with an 8 mega pixel, auto focusing camera. The camera adjusts on a vertical plane as low as two feet and as high as seven fee. It will take photos and each photo will include the frame brand and type. Multiple photos can be compared next to each other. The system will collect user data and will e-mail the images so the consumer can see how frames fit their face

### CROSS-REFERENCES TO RELATED APPLICATIONS

None.

### STATEMENT AS TO RIGHTS TO INVENTIONS MADE UNDER FEDERALLY SPONSORED RESEARCH AND DEVELOPMENT

None

### FIELD OF THE INVENTION

The purpose of this application is to provide a platform for the users to try on various eye frames and take photos. These photos can be saved on a device, app gallery and the user can share the pictures to or to friends and family via email or social media. This will allow the user to help decide which frames looks best on them.

### BACKGROUND OF THE INVENTION

More and more people are using eyeglasses. How these look effect a person's appearance and their first impression.

Today there is no easy way to compare how a person looks in one eyeglass frames versus another that is easy to use by direct comparison.

There remains room for improvement in the art.

### SUMMARY OF THE INVENTION

The invention is a system and device that allows people to choose the proper eyeglass frames. A kiosk or other unit is used. It is equipped with an 8 mega pixel, auto focusing camera. The camera adjusts on a vertical plane as low as two feet and as high as seven fee. It will take photos and each photo will include the frame brand and type. Multiple photos can be compared next to each other. The system will collect user data and will e-mail the images so the consumer can see how frames fit their face.

The system will work with a computer application that can be run on a smart phone or computing device.

The current invention is the perfect way to engage with customers to ensure they get the frames that are right for them without tying up support staff.

### BRIEF DESCRIPTION OF DRAWINGS

Without restricting the full scope of this invention, the preferred form of this invention is illustrated in the following drawings in which:

FIG. 1 shows a sample kiosk system;

FIG. 2 shows a top view of the kiosk;

FIG. 3 shows a bottom view of the kiosk;

FIG. 4 shows a front view of the kiosk;

FIG. 5 shows a back view of the kiosk;

FIG. 6 shows a right side view of the kiosk;

FIG. 7 shows a left side view of the kiosk;

FIG. 8 shows a right front view of the kiosk;

FIG. 9 shows a left front view of the kiosk;

FIG. 10 shows a flowchart of the system; and

FIG. 11 shows the system architecture.

### DETAILED DESCRIPTION OF THE PREFERRED EMBODIMENT

There are a number of significant design features and improvements incorporated within the invention.

The current invention is a device and system that allows customers to get the proper eyeglass frames.

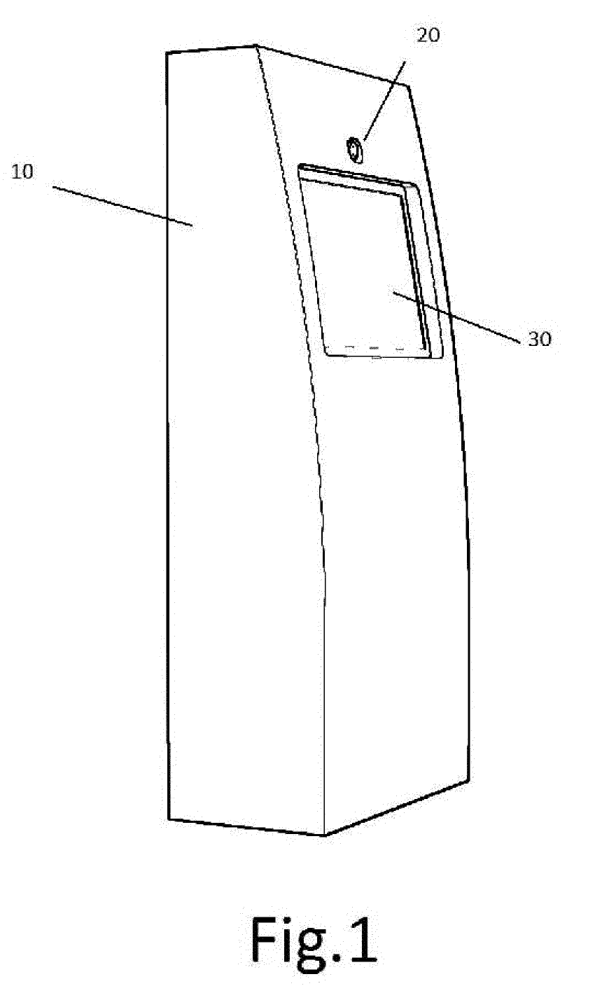

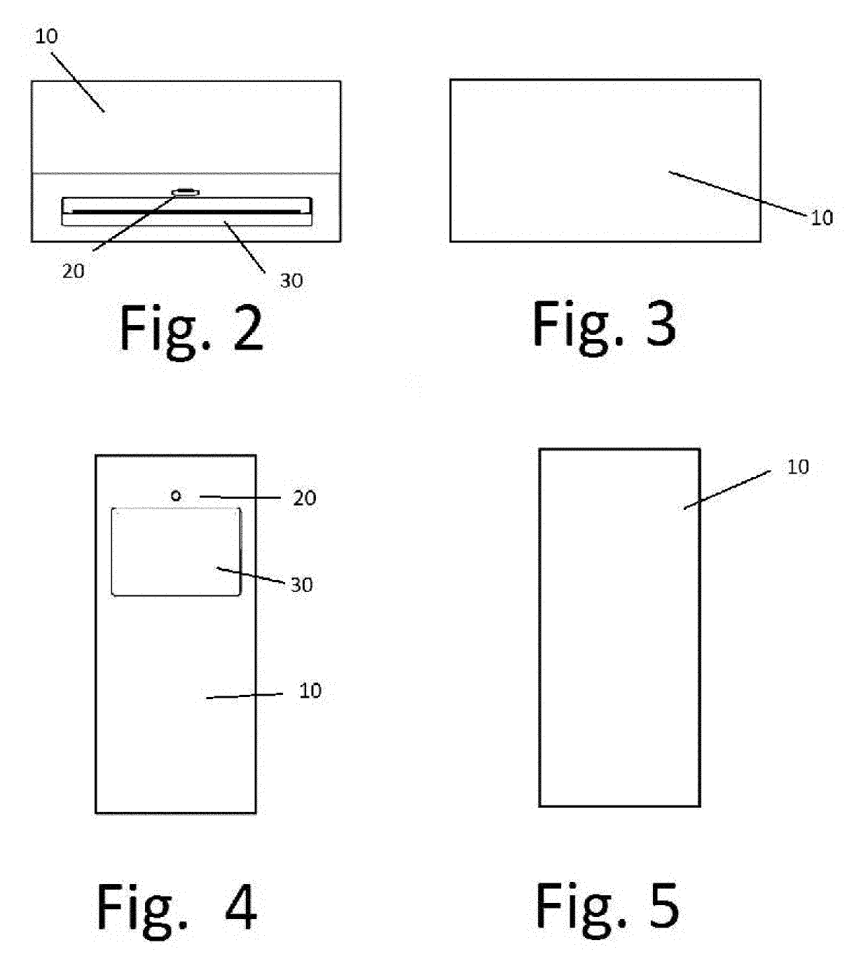

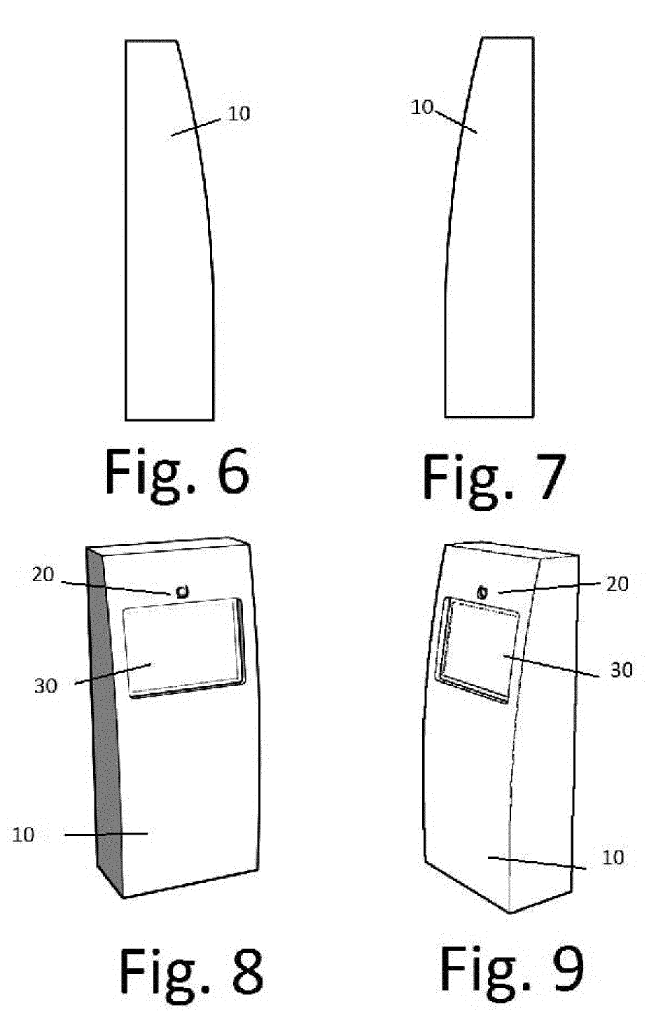

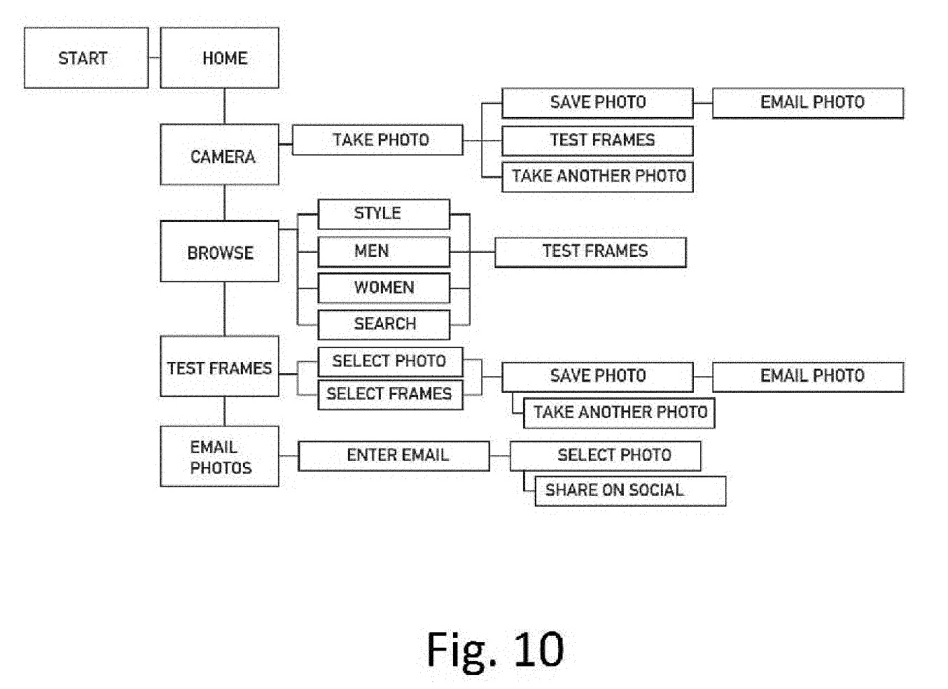

In the preferred embodiment, a kiosk 10 or other similar unit is used with the system. The kiosk 10, as shown in FIGS. 1 through 9, would be placed at a location that would be easy for the user to access such as in a lobby of a store. The kiosk 10 would have a computing means such as a microprocessor and transmitting means like wireless connecting means.

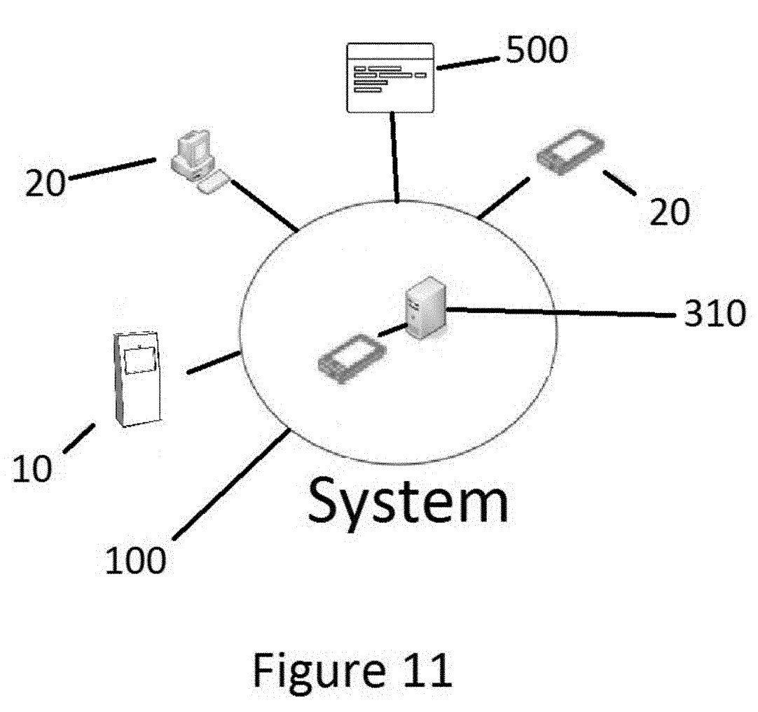

FIG. 11 displays the preferred embodiment of the system architecture 1 that can be accessed through an Internet, Intranet and/or Wireless network. The system 1 is set to run on a kiosk 10, a computing device 20 or a website 500. A computing device 20, such as a cell phone/smart phone, that can access the system 1 must have some version of a CPU, CPU memory, local hard disk, keyboard/keypad/input and display unit.

The computing devices 20 can be any desktop, laptop, tablet, smart phone or general purpose computing device with an appropriate amount of memory suitable for this purpose and an active connection to the Internet or a wireless network. Computing devices like this are well known in the art and are not pertinent to the invention.

The system 1, data, photos and processing code can reside in the non-transitory memory 310 of the kiosk 10 and/or one or more computing devices. The system 1 in the preferred embodiment would be written to act like a smart phone application (app).

The system 1, data and processing code can reside in the non-transitory memory 310 of the kiosk 10 and/or one or more computing devices. The system 1 in the preferred embodiment would be written to act like a smart phone application (app) and would have a touch screen 100 to allow a user to swipe the screen when making choices and decisions.

The kiosk 10 or other similar unit would be equipped with an 8 mega pixel, auto focusing camera 20. The camera 20 adjusts on a vertical plane as low as two feet and as high as seven fee. The user would stand in front of the kiosk 10 and it will take a series of photos and each photo will include the frame brand and type. Multiple photos can be compared next to each other. The system will collect user data and will email the images so the consumer can see how frames fit their face.

The kiosk 10 will have a display unit 30 which can display the photos which in the preferred embodiment has a touch screen.

The system can be processed as a mobile computer application (app) that would run on the kiosk 10 or other computing device 20. The process will have the following steps.

To use the system, the user would first register their e-mail and/or text ID, name(first name, last name) and password into the system. The system will send an e-mail or text verification in the preferred embodiment.

After registration of the user, to use the app, the user will then have to log in with the same e-mail or text ID and password. At any point, the user can change their app password.

The user can take photos at the kiosk or another camera with the eyeglasses on. They will be shown a 5 second countdown before taking a picture with a reminder to put on the glasses. Once the photo is taken, the system will display a popup with options to continue or discard. If the user presses discard, then the photo will be discarded and user will have the option to re-take photo. If the user presses continue, then the user needs to provide a category of frames (men, women, kids, unisex) and press OK. The photo will be saved in the app gallery, and e-mail or SMS text will be sent to the user with the photo. In both the cases, another popup will appear with the user to choose to take photo with different frame and the same process if the user clicks yes.

The display unit 30 will show a dashboard that will display the saved photos with the most recently taken photos which are grouped together into a gallery. The user can filter the photos based on the category. The user has the option to select any photo to share it to an e-mail address, text it, re-send the photo to their own e-mail address or share the photo on social media (such as Facebook and Instagram). The user can also select multiple photos to delete them from the app gallery.

From the settings for the app, the user can change their name, turn on/off the option to save images to the phone gallery, view terms and conditions and logout.

The system would be user friendly with a touch screen. The system would keep track of frames that are used (drop down menu with model number or frames). The system will show a options for frames for the user to place on the image. Thumbnail images will be send via electronic e-mail or SMS. then the system can collect the e-mail info for sales, etc.

Operation

The user would start the system. The user would use the camera to take a photo and save the photo if the user chooses to and E-mail the photo. The user can test eyeglass frames. The user can take another photo if desired.

The user can browse and search for different styles of frames such as frames for men and women.

The user would then test the different frames by searching different frames and selecting a part of frames and pairing it will a photo of the user to form a new image. The user can save the image and send it electronically to someone or choose another photo the use.

### ADVANTAGES

The device and system provides great benefit to customers with poor vision. Now they can take multiple pictures and clearly see how the frames fit their face for they will now be viewing the photos with their prescription glasses on.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur by those skilled in the art, it is not desired to limit the invention to the exact construction and operation shown and described, and accordingly, all suitable modifications and equivalents may be resorted to, falling within the scope of the invention.

I claim:

1. A system comprising;
having a system that resides in the non-transitory memory of a computing device;
having a camera;
placing an image of eyeglass frames on a user;
using the camera to take a picture of the user;
storing the image;
repeating the previous three steps; and
comparing all the images taken.

2. A system according to claim 1 where the computing device is a kiosk.

3. A system according to claim 1 further comprising sending the images electronically. the glasses.

4. A system according to claim 1 further comprising after taking the photo displaying a popup with an option to continue or discard the photo.

5. A system according to claim 4 further comprising discarding the photo if the discard option is chosen.

6. A system according to claim 4 further comprising if continue is chosen the image is stored.

7. A system according to claim 6 further comprising a category for the image is selected.

8. A system according to claim 6 further comprising where the photo is saved in a gallery.

9. A system according to claim 6 further comprising where an electronic message is sent to the user.

10. A system according to claim 6 further comprising where a new popup will appear asking to take another photo with a new eyeglass frame or end the process.

11. A system according to claim 10 further comprising where if end the process is chosen the process will end.

12. A system according to claim 10 further comprising a having a display unit.

13. A system according to claim 12 further comprising a having the display unit display the photos.

14. A system according to claim 12 further comprising a grouping the photos into galleries and having the display unit display the photos.

15. A system according to claim 12 further comprising having the display unit have a touch screen.

16. A device comprising;
A kiosk with a camera having a system that resides in the non-transitory memory of a computing device;
having a camera;
having a having the display unit have a touch screen;
having a computing means;
placing eyeglass frames on a user;
using the camera to take a picture of the user;
storing the image;
repeating the previous three steps; and
comparing all the images taken.

17. A device according to claim 16 further comprising having the camera adjust on a vertical plane as low as two feet and as high as seven feet.

18. A device according to claim 16 further comprising having the camera have 8 mega pixel and auto focusing.

19. A device according to claim 16 further comprising a having the display unit display the photos.

20. A device according to claim 19 further comprising a grouping the photos into galleries.
